(19) United States
(12) Patent Application Publication
(10) Pub. No.: US 2013/0014646 A1
(43) Pub. Date: Jan. 17, 2013

(54) Vents A/C Filter

(71) Applicants: Miguel Rojas, Aurora, IL (US); Miriam V. Cabrera, Aurora, IL (US); Dulce M. Cabrera, Aurora, IL (US)

(72) Inventors: Miguel Rojas, Aurora, IL (US); Miriam V. Cabrera, Aurora, IL (US); Dulce M. Cabrera, Aurora, IL (US)

(21) Appl. No.: 13/549,315

(22) Filed: Jul. 13, 2012

Related U.S. Application Data
(60) Provisional application No. 61/572,378, filed on Jul. 13, 2011.

(51) Int. Cl. B01D 46/00

(52) U.S. Cl. 96/222; 55/495

(57) ABSTRACT

The invention provides an air filter system specially designed to fit over the air conditioning and heat vents located on the dashboard of a vehicle. The filter provides an adhesively attached filter containing activated charcoal and an air freshening scent to provide a more pleasant and healthy intake of air.

### CLAIM OF PRIORITY

This patent application claims priority under 35 USC 119 (e) (1) from U.S. Provisional Patent Application Ser. No. 61/572,378 filed Jul. 13, 2011, of common inventorship herewith entitled, “Vents A/C Filter.”

### FIELD OF THE INVENTION

The present invention pertains to the field of automotive accessories, and more specifically to the field of air filters for air conditioning and heating vents in vehicles.

### BACKGROUND OF THE INVENTION

The prior art has put forth several designs for vehicular air vent filters. Among these are:

US Patent 2007/0287374 to Timothy Day and Kathy Hermreck describes an improved system to allow users to filter air by installing an apparatus between the passenger space and the air circulating from the outside of a vehicle, proximate to existing vents, or as a mechanically elegant improvement to new systems. A hings mechanism allows a venting system to open reliably and a filter element discretely cleans air passing through it.

US Patent 2006/0005711 to Andrew Olefson describes a replaceable air filter for a vehicle air conditioning system that employs a pleated porous filter media coated with a perfume polymer composition to impart a long lasting scent to air passing through the filter.

US Patent 2002/0139251 to Brenda Joyce Simmons describes an air filtration system for vehicles, aircraft and spacecraft including a removable filter element for filtering air passing through an air vent thereby cleaning the air of toxic substances. The system emits a fragrance while cleaning the air.

None of these prior art references describe the present invention.

### SUMMARY OF THE INVENTION

It is an object of the present invention to provide an improved air filter system designed to fit over air conditioning and heat vents located in vehicles, including automobiles, trucks and tractors.

### BRIEF DESCRIPTION OF THE DRAWINGS

FIG. 1 is close up front view showing a vehicle's air vent located on the vehicle's dashboard. An inset illustration shows the present invention installed in the air vent.

FIG. 2 is close up front view of the inset illustration of FIG. 1 of the present invention installed a vehicle's air vent.

FIG. 3 shows a cover, a filter sheet and an air freshener sheet that are the components installed into a vehicle's air vent.

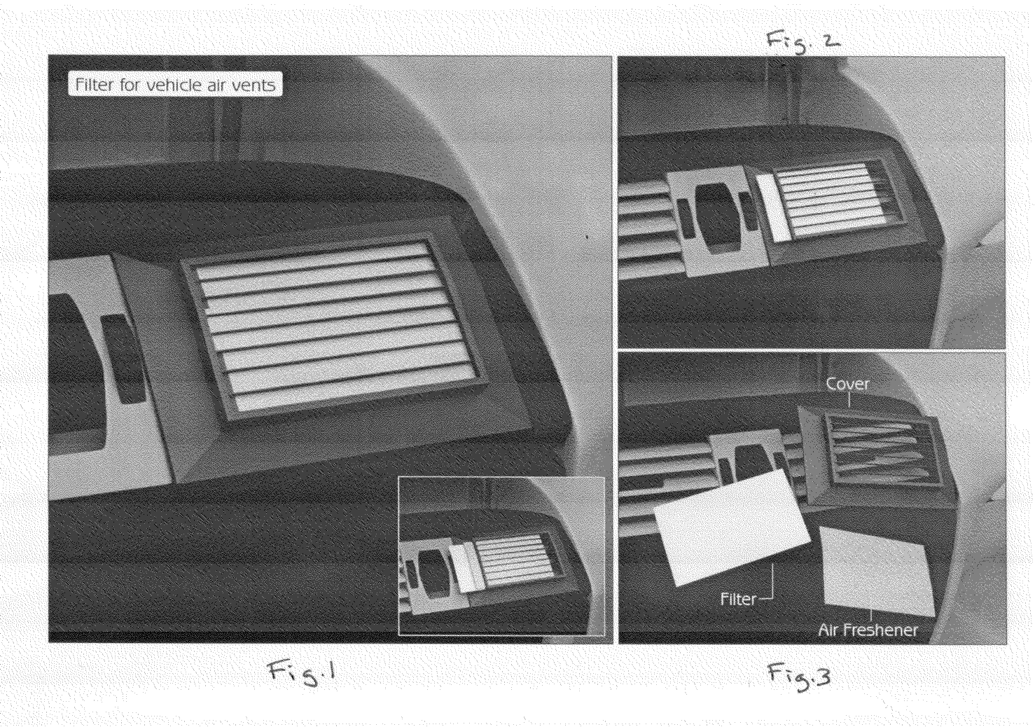

### DETAILED DESCRIPTION OF THE INVENTION

Airborne allergens cause sneezing, runny nose and itchy, bloodshot eyes. Whether dust, mold, pollen or pet dander, airborne allergens also affect the lining of the lungs and cause asthma. Allergens also cause conjunctiva of the eye, which results in conjunctivitis or pink eye or other illnesses. Many consumers employ dehumidifiers or air purifiers in their homes to capture airborne particles through a filtering system. While these devices are effective in reducing allergens in the home, dehumidifiers and air purifiers are not portable and usable in consumers' vehicles. Vehicle air conditioning and heating systems depend upon the intake of outside air to cool or warm the car, so the inside of the vehicle becomes rife with airborne allergens such as dust and pollen. These allergens compromise the health and well being of the occupants.

The present invention, hereinafter referred to as the Vents A/C Filter, is an air filter system specially designed to fit over the air conditioning and heat vents located on the dashboard of a vehicle. The Vents A/C Filter provides a more pleasant and healthy intake of air. Each Vents A/C Filter is rectangular or any other shape to accommodate the shape of vents commonly found in automobiles. To facilitate attachment of the present invention over the vent, one or both sides of the filter is coated with a strong and easily removable adhesive material. Although the shape of the filter shown is essentially round, it is contemplated that the invention encompasses oval, rectangular, and any other shapes to accommodate the air vent of a vehicle. The shape of the filter is round, oval, rectangular, square, or other polyhedra to accommodate the shape of a vent.

In an alternative embodiment, the filter is available in sheets to be cut by a user to accommodate the shape of a vent.

The filtering component is a form of activated charcoal, which is a safe, effective filtering agent for extracting liquids and gases from their harmful elements. The filter comprises a layer of activated charcoal sandwiched between a top layer and a bottom layer of filter material. The filter material may comprise any suitable filter material, such as woven or felted fibers, for example. The fibers include any suitable fiber such as cotton, polyester, polyurethane, or polypropylene, for example. The foam comprises any suitable foam such as polyester, polyurethane, or polypropylene, for example.

The filters also comprise an air freshening component. The scent can be any desired scent. Some possibilities include spicy sensual musk and botanical scents to fruit aromas and environmental smells, alone or in combination, for example. The Vents A/C Filter is packaged with four or more units per box, to accommodate all vents inside the vehicle.

The filter of the present invention is useful not only on passenger vehicles, such as cars, vans and buses, but also on trucks, farm equipment, heavy construction equipment, cargo equipment and aircraft including commercial, private, government, military, NASA aircraft.

In an alternative embodiment, the unit may additionally include LED lights for illumination.

Use and application of the Vents A/C Filter is very simple and straightforward. The user places a filter over a vent and activates the auto's air conditioning system. The Vents A/C Filter begins capturing airborne allergens before they enter the confines of the vehicle. Each filter absorbs pathogens as well as odors by chemical attraction. The surface area of activated charcoal provides countless bonding sites. When certain chemicals pass next to the carbon surface, they attach to the surface and are trapped. After a period of use, the Vents A/C Filter is removed easily and discarded in a trash receptacle. The user then replaces the discarded Vents A/C Filter with a new one.

The Vents A/C Filter provides a simple, affordable means for allergy sufferers to combat airborne allergens while operating a motor vehicle. A compact filtering system directly installed over an air vent, the Vents A/C Filter offers a portable and low cost solution for blocking out pollen, dust, mold or pet dander from entering an automobile. The present inventions' air freshening capabilities effectively resist foul odors. Consumers can keep the Vents A/C Filter on hand whenever encountering a foul stench, such as driving through an area that reeks from pollution. Extremely easy to use, a Vents A/C Filter insert can be applied and removed in just a matter of seconds. Safe for use by motorists as well as their passengers, this practical product is ideal for both children and adults.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An air filter system designed to fit over air conditioning and heat vents located in vehicles, comprising: a filter to accommodate the shape of vents commonly found in automobiles; removable adhesive material on one or both sides of the filter, the filter comprising a layer of activated charcoal sandwiched between a top layer and a bottom layer of filter material.

2. The filter of claim 1 wherein the filter material is scented.

3. The filter of claim 2 wherein the filter material is comprised of fibers.

4. The filter of claim 2, wherein the filter material is comprised of foam.

5. The filter of claim 2 wherein the scent is any of a variety of scents including, but not limited to: spicy sensual musk, botanical scents, fruit aromas, environmental smells, alone or in combination.

6. The filter of claim wherein the filter is packaged with four or more units per box, to accommodate all vents inside the vehicle.

7. The filter of claim 3 wherein the fibers are cotton, polyester, polyurethane, or polypropylene.

8. The filter of claim 4, wherein the foam is polyester, polyurethane, or polypropylene.

9. The filter of claim 1 wherein the shape of the filter is round, oval, rectangular, square, or other polyhedra to accommodate the shape of a vent.

10. The filter of claim 1 available in sheets to be cut by a user to accommodate the shape of a vent.

11. The filter of claim 2 further comprising an LED light mounted on the top layer of the filter for illumination
